(19) United States
(12) Patent Application Publication
(10) Pub. No.: US 2013/0179854 A1
(43) Pub. Date: Jul. 11, 2013

(54) DESIGN APPARATUS, METHOD FOR DESIGNING SEMICONDUCTOR INTEGRATED CIRCUIT, AND NON-TRANSITORY MEDIUM STORING PROGRAM FOR DESIGNING SEMICONDUCTOR INTEGRATED CIRCUIT

(71) Applicant: Naohito KOJIMA, Yokohama-shi (JP)

(72) Inventor: Naohito KOJIMA, Yokohama-shi (JP)

(73) Assignee: KABUSHIKI KAISHA TOSHIBA, Tokyo (JP)

(21) Appl. No.: 13/478,040

(22) Filed: May 22, 2012

(30) Foreign Application Priority Data
Jan. 11, 2012 (JP) 2012-3001

(51) Int. Cl. G06F 17/50

(52) U.S. Cl. 716/134

(57) ABSTRACT

According to one embodiment, a design apparatus includes a voltage drop analyzer, an improvement calculator, first and second cell replacing modules, and an outputting module. The voltage drop analyzer specifies a peak voltage drop point based on a cell library and design data. The cell library includes information on first and cell groups. The first cell replacing module changes the design data. The improvement calculator calculates a timing improvement. The second cell replacing module extracts at least one cell from second cell group in a target device corresponding to the design data changed by the first cell replacing module as a replacement candidate cell, based on the timing improvement, and changes the design data changed by the first cell replacing module. The outputting module outputs the design data changed by the second cell replacing module.

### CROSS REFERENCE TO RELATED APPLICATION(S)

This application is based upon and claims the benefit of priority from the prior Japanese Patent Application No. 2012-3001, filed on Jan. 11, 2012; the entire contents of which are incorporated herein by reference.

### FIELD

Embodiments described herein relate generally to a design apparatus, a method for designing a semiconductor integrated circuit, and a non-transitory medium storing a program for designing the semiconductor integrated circuit.

### BACKGROUND

Generally, in design of a semiconductor integrated circuit, a plurality of resistors are placed, a data path connecting the plurality of resistors is placed, a logical cell that performs a logical operation on a data signal flowing on the data path is placed, and a threshold voltage of the logical cell (that is, a type of the logical cell) is changed in order to reduce a leak current of the semiconductor integrated circuit.

In the change of the type of the logical cell, it is required that the semiconductor integrated circuit meets a predetermined timing constraint, and it is desirable that a variation (hereinafter referred to as a “supply voltage drop error”) in the voltage drop amount of a power supply routing is minimized.

However, in conventional change of the type of the logical cell, since the logical cell to be changed is determined without consideration of the voltage drop amount of the power supply routing, the supply voltage drop error cannot be reduced although the leak current can be reduced while the timing constraint is met. As a result, a yield of the semiconductor integrated circuit is decreased due to the high supply voltage drop error.

### BRIEF DESCRIPTION OF THE DRAWINGS

FIG. 1 is a block diagram illustrating a configuration of a design apparatus 10 of the embodiment.

FIG. 2 is a flowchart of a design process of the embodiment.

FIG. 3 is a schematic diagram illustrating a result of the first timing analysis (S104) of the embodiment.

FIG. 4 is a flowchart illustrating the extraction of the replacement candidate cell (S108) of the embodiment.

FIG. 5 is a schematic diagram illustrating a result of S108-1 of the embodiment.

FIG. 6 is an explanatory view of the extraction in S108-2 of the embodiment.

FIG. 7 is a flowchart illustrating the extraction of the second replacement candidate cell (S108-4) of the embodiment.

FIG. 8 is an explanatory view illustrating the extraction of the second replacement candidate cell (S108-4) of the embodiment.

FIG. 9 is an explanatory view illustrating an effect of the comparative example of the embodiment.

FIG. 10 is an explanatory view illustrating an effect of the embodiment.

FIG. 11 is an explanatory view illustrating an effect of the first modification of the embodiment.

FIG. 12 is an explanatory view illustrating an effect of the second modification of the embodiment.

FIG. 13 is an explanatory view illustrating an effect of the third modification of the embodiment.

### DETAILED DESCRIPTION

Embodiments will now be explained with reference to the accompanying drawings.

In general, according to one embodiment, a design apparatus includes a voltage drop analyzer, a first cell replacing module, an improvement calculator, a second cell replacing module, and an outputting module. The voltage drop analyzer specifies a peak voltage drop point at which the voltage drop amount becomes a maximum based on a cell library and design data. The cell library includes information on a first cell group and information on a second cell group. Each cell of the first cell group is operated by a first operational threshold. Each cell of the second cell group is operated by a second operational threshold higher than the first operational threshold. The design data indicates a hardware configuration of a target device including the first cell group. The first cell replacing module changes the design data in such a manner that each cell of the first cell group replaceable on a data path is replaced by each cell of the second cell group. The improvement calculator calculates a timing improvement that is amount of improved operation timing. The timing improvement is obtained by replacing each cell of the second cell group, which is comprised in the target device corresponding to the design data changed by the first cell replacing module, by each cell of the first cell group. The second cell replacing module extracts at least one cell from the second cell group in the target device corresponding to the design data changed by the first cell replacing module as a replacement candidate cell, based on the timing improvement, and changes the design data changed by the first cell replacing module in such a manner that the replacement candidate cell is replaced by each cell of the first cell group. The outputting module outputs the design data changed by the second cell replacing module.

Definitions of terms of the embodiment will be described below.

In the embodiment, a first cell group and a second cell group mean functional blocks included in a semiconductor integrated circuit (hereinafter referred to as a “target device”) to be designed. Each cell (hereinafter referred to as a “first cell”) of the first cell group is operated based on a first operational threshold. Each cell (hereinafter referred to as a “second cell”) of the second cell group is operated based on a second operational threshold. The second operational threshold is higher than the first operational threshold. That is, the first cell is operated faster than the second cell, while a leak current of the first cell is larger than that of the second cell.

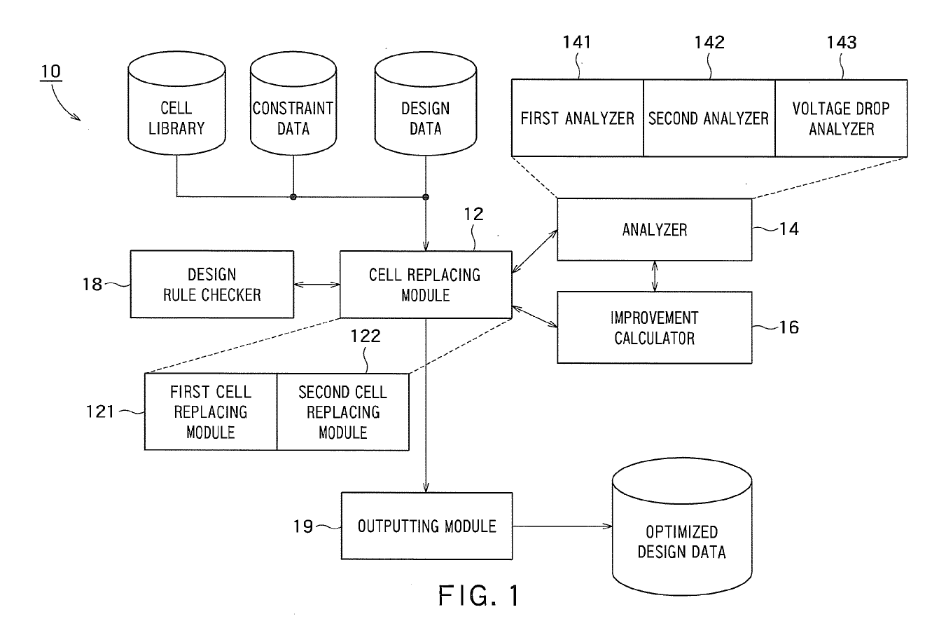

A configuration of a design apparatus of the embodiment will be described. FIG. 1 is a block diagram illustrating a configuration of a design apparatus 10 of the embodiment.

As illustrated in FIG. 1, a cell library, constraint data, and design data are inputted to the design apparatus 10, and the design apparatus 10 outputs optimized design data. For example, the design apparatus 10 is constructed such that a computer processor starts a computer program.

The cell library means data indicating information (for example, a type, an operating speed, and a leak current) on a component (hereinafter referred to as a “cell”) used in the target device. The cell library includes information on the first cell and information on the second cell.

The constraint data means data indicating a timing constraint of the target device. For example, the constraint data is SDC (Synopsys Design Constraints) data.

The design data means data indicating a hardware configuration (a module (for example, a cell and a power supply routing) used in the hardware configuration and a layout (for example, a position) of the module) of the target device. The first cell is included in the target device indicated by the design data. That is, the design data is generated in consideration of the timing constraint. The optimized design data means data that is obtained by optimizing the design data such that a supply voltage drop error of the target device is reduced. A cell that is included in the target device indicated by the optimized design data is a combination of the first cell and the second cell. That is, the optimized design data is generated in consideration of the timing constraint and the leak current. For example, the design data and the optimized design data are Verilog data.

The design apparatus 10 includes a cell replacing module 12 (a first cell replacing module 121 and a second cell replacing module 122), an analyzer 14 (a first analyzer 141, a second analyzer 142, and a voltage drop analyzer 143), an improvement calculator 16, a design rule checker 18, and an outputting module 19. Each module of the design apparatus 10 is described later.

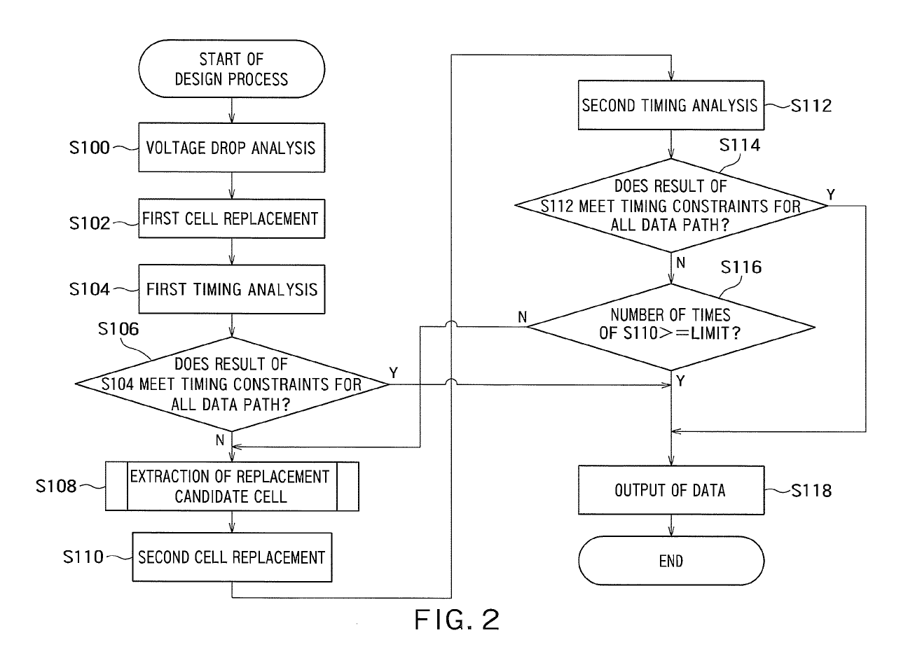

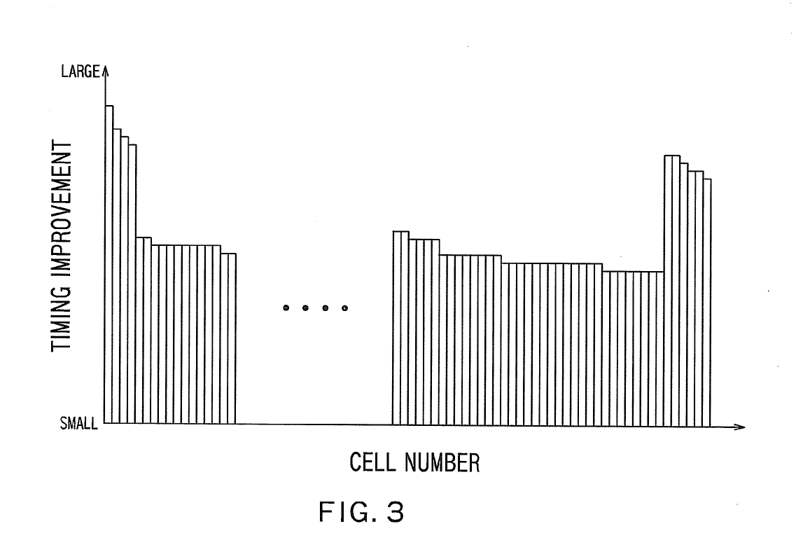

An operation of the design apparatus of the embodiment will be described. FIG. 2 is a flowchart of a design process of the embodiment.

<S100> In a supply voltage drop analysis, based on the cell library and the design data, the voltage drop analyzer 143 calculates the voltage drop amount of the power supply routing constituting the target device corresponding to the design data. Then, the voltage drop analyzer 143 specifies a position (hereinafter referred to as a “peak voltage drop point”) of the power supply routing. In peak voltage drop point, the voltage drop amount becomes a maximum.

<S102> In a first cell replacement, the first cell replacing module 121 changes the design data such that each cell (hereinafter referred to as a “replaceable cell”) replaceable on a data path in the first cell group included in the target device corresponding to the design data are replaced by each cell of the second cell group. For example, the first cell replacing module 121 changes a description corresponding to the first cell in Verilog data as a description corresponding to the second cell.

<S104> In a first timing analysis, the first analyzer 141 calculates operation timing corresponding to the design data obtained in S102. Then, the improvement calculator 16 calculates a timing improvement with respect to the second cell which is included in the target device corresponding to the design data obtained in S102. The timing improvement means amount of the improved operation timing that is obtained by replacing the second cell by the first cell. Therefore, the timing improvement is obtained with respect to each cell of the second cell group. FIG. 3 is a schematic diagram illustrating a result of the first timing analysis (S104) of the embodiment.

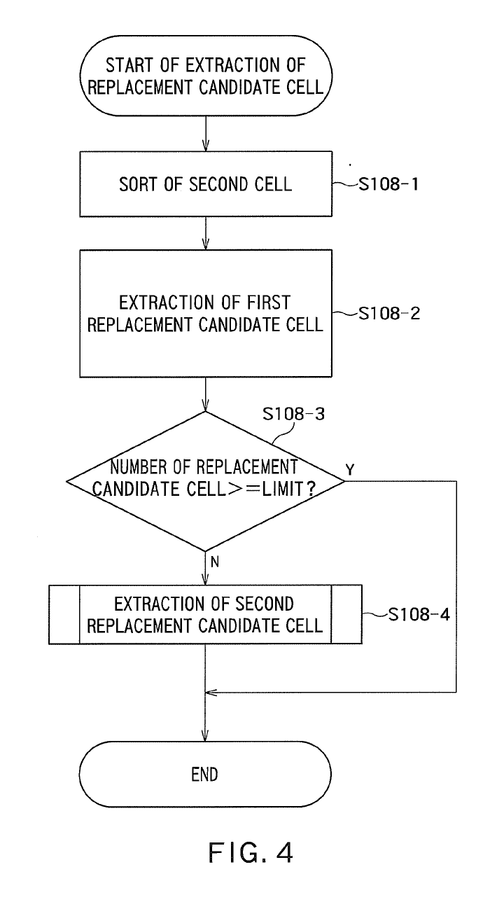

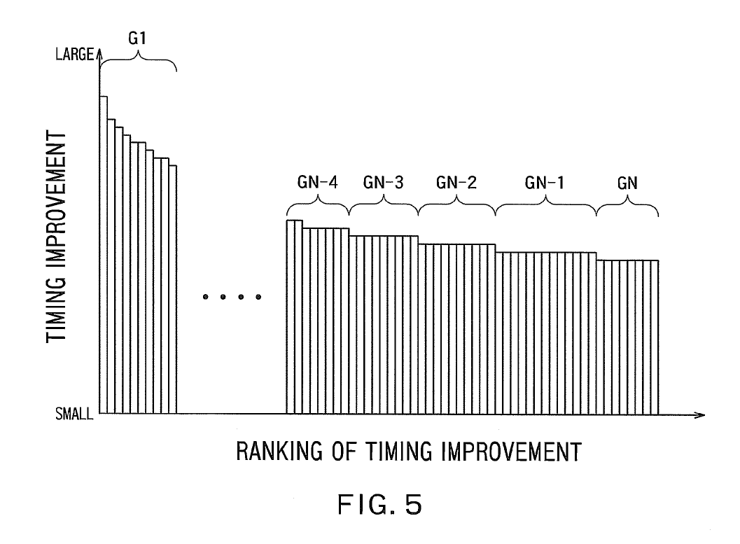

In FIG. 3, a horizontal axis indicates a cell number and a vertical axis indicates the timing improvement. The cell number means information identifying the second cell. As illustrated in FIG. 3, a relationship between the cell number and the timing improvement is obtained in S104.

<S106> The design rule checker 18 determines whether the result of S104 meets the timing constraints corresponding to the constraint data for all the data paths. When the result of S104 meets the timing constraints for all the data paths (YES in S106), the flow goes to S118. On the other hand, when the result of S104 does not meet the timing constraints (NO in S106), the flow goes to S108.

<S108> In an extraction of a replacement candidate cell, the second cell replacing module 122 extracts a replacement candidate cell based on the timing improvement. FIG. 4 is a flowchart illustrating the extraction of the replacement candidate cell (S108) of the embodiment.

<S108-1> The cell replacing module 12 sorts each cell of the second cell group based on the timing improvement (for example, in the ascending order of timing improvement). Therefore, a group in which the timing improvements come near each other is obtained. FIG. 5 is a schematic diagram illustrating a result of S108-1 of the embodiment.

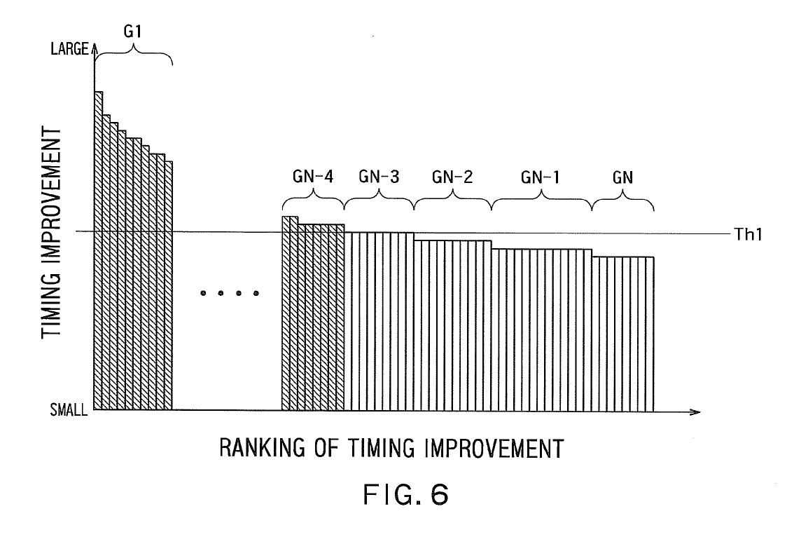

In FIG. 5, a horizontal axis indicates a ranking of timing improvement and a vertical axis indicates the timing improvement. As illustrated in FIG. 5, N (N is a natural number) groups G1 to Gn (n=1 to N) in each of which the timing improvements come near each other are obtained in S108-1.

<S108-2> In an extraction of first replacement candidate cell, the second cell replacing module 122 extracts the second cell in which the timing improvement is larger than a first timing threshold Th1 as the first replacement candidate cell. FIG. 6 is an explanatory view of the extraction in S108-2 of the embodiment.

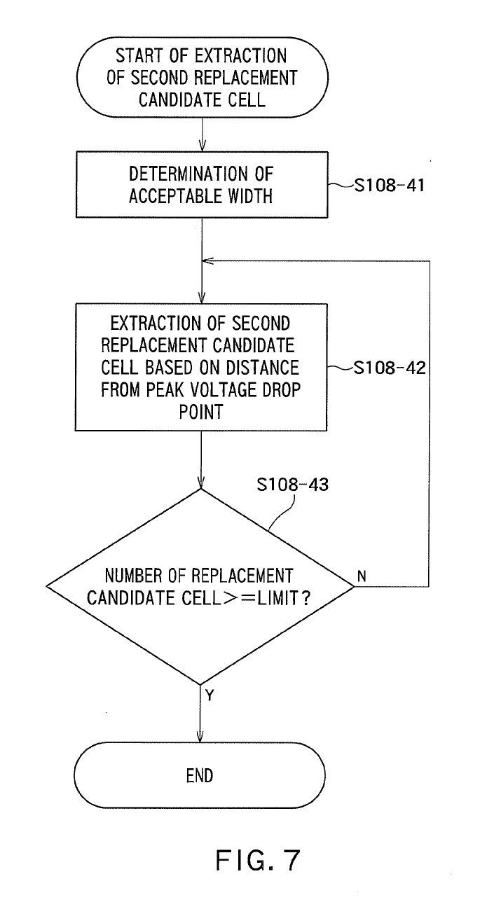

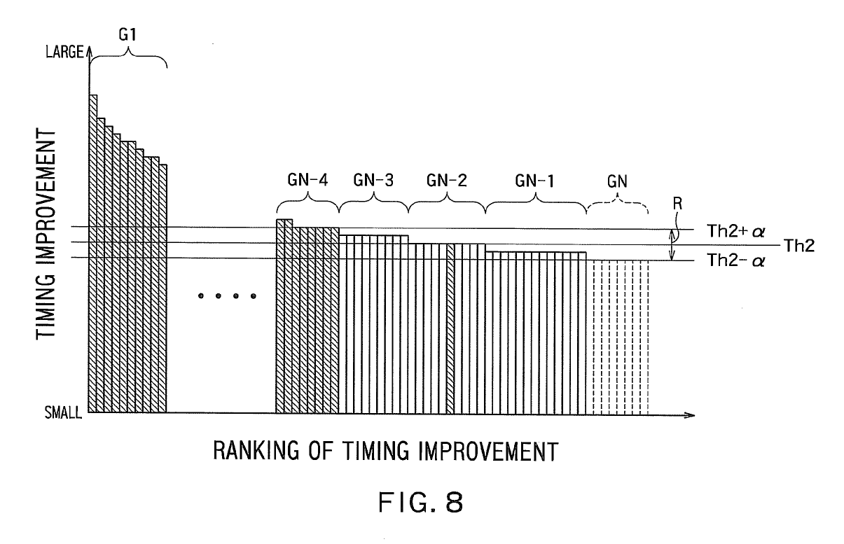

In FIG. 6, a horizontal axis indicates the ranking of timing improvement and a vertical axis indicates the timing improvement. As illustrated in FIG. 6, in S108-2, the second cell (that is, each cell of the second cell group belonging to groups G1 to GN-4) in which the timing improvement is larger than the first timing threshold Th1 is obtained as the first replacement candidate cell.

<S108-3> When the number of the first replacement candidate cell is equal to an upper limit (for example, m % (m is a positive number) of all the cells) (YES in S108-3), the extraction of the replacement candidate cell is ended and the flow goes to S110. On the other hand, when the number of the first replacement candidate cell is less than the upper limit (NO in S108-3), the flow goes to S108-4.

<S108-4> In an extraction of a second replacement candidate cell, the second cell replacing module 122 extracts at least one cell of the second cell group in which the timing improvement is equal to or smaller than the first timing threshold Th1 as the second replacement candidate cell. FIG. 7 is a flowchart illustrating the extraction of the second replacement candidate cell (S108-4) of the embodiment. FIG. 8 is an explanatory view illustrating the extraction of the second replacement candidate cell (S108-4) of the embodiment.

<S108-41> The second cell replacing module 122 determines an acceptable range R (Th2−α≦R≦Th2+α) around a second timing threshold Th2 smaller than the first timing threshold Th1 (Th2<Th1). α is a predetermined value.

<S108-42> The second cell replacing module 122 extracts at least one cell (that is, the second cell in which the timing improvement is equal to or smaller than the first timing threshold Th1) of the second cell group, which is included in the acceptable range R determined in S108-41, as the second replacement candidate cell based on a distance (hereinafter referred to as a “peak voltage drop point distance”) from a peak voltage drop point. For example, the second cell replacing module 122 extracts the second cell having the maximum peak voltage drop point distance as the second replacement candidate cell.

Incidentally, in the case that the peak voltage drop point Pmax tends to emerge in a specific region (for example, a center) of the semiconductor integrated circuit, the second cell replacing module 122 may extract one cell of the second cell group, which is included in the acceptable range R determined in S108-41, as the second replacement candidate cell based on the distance from the specific region.

Moreover, in the case that the peak voltage drop point Pmax tends to emerge in a specific cell (for example, a memory cell) of the semiconductor integrated circuit, the second cell replacing module 122 may extract one cell of the second cell group, which is included in the acceptable range R determined in S108-41, as the second replacement candidate cell based on the distance from the specific component.

<S108-43> When the number of replacement candidate cells (that is, the total number of the first and second replacement candidate cells) is equal to the upper limit (YES in S108-43), the extraction of second replacement candidate cell is ended, and the flow goes to S110. On the other hand, when the total number is less than the upper limit (NO in S108-43), the flow goes to S108-4.

In FIG. 8, a horizontal axis indicates the ranking of timing improvement and a vertical axis indicates the timing improvement. As illustrated in FIG. 8, the acceptable range R is determined in S108-41. In S108-42, the second cell (one cell of the second cell group belonging to the group GN-2) having the maximum peak voltage drop point distance in the second cell (cell of the second cell group belonging to the groups GN-3 to GN-1) included in the acceptable range R is extracted as the second replacement candidate cell. When the number of replacement candidate cells (that is, the total number of cells of the second cell group belonging to the groups G1 to GN-4 and of the second cell group belonging to the group GN-2) is equal to or higher than m % of the whole (that is, the number of cells included in the target device), the second cell group belonging to the groups G1 to GN-4 and one cell of the second cell group belonging to the group GN-2 are the replacement candidate cells.

<S110> In a second cell replacement, the second cell replacing module 122 changes the design data obtained in S102 such that the replacement candidate cell (that is, each cell of the second cell group) obtained in S108 are replaced by each cell of the first cell group. For example, the second cell replacing module 122 changes a description corresponding to the replacement candidate cell of the Verilog data as a description corresponding to the first cell.

<S112> In a second timing analysis, the second analyzer 142 calculates the operation timing with respect to the design data obtained in S110.

<S114> The design rule checker 18 determines whether the result of S112 meets the timing constraints corresponding to the constraint data for all the data paths. When the result of S112 meets the timing constraints for all the data paths (YES in 114), the flow goes to S118. On the other hand, when the result of S112 does not meet the timing constraints for at least one of the data paths (NO in 114), the flow goes to S116.

<S116> When the number of times of the second cell replacement (S110) is less than a predetermined upper limit (NO in S116), the flow returns to S108. On the other hand, when the number of times of the second cell replacement (S110) is equal to a predetermined upper limit (YES in S116), the flow goes to S118.

<S118> In output of data, the outputting module 19 outputs the design data (that is, the design data obtained in S102 or the design data obtained in S110) meeting the timing constraints as the optimized design data to the outside of the design apparatus 10. For example, the outputting module 19 writes a file corresponding to the optimized design data in a memory (not illustrated) connected to the design apparatus 10.

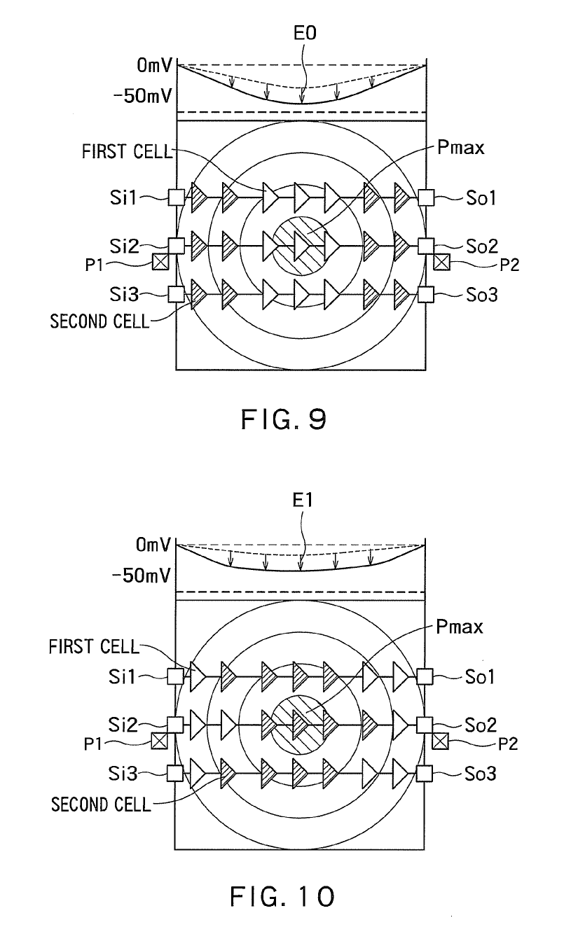

A comparative example of the embodiment will be described. FIG. 9 is an explanatory view illustrating an effect of the comparative example of the embodiment. FIG. 10 is an explanatory view illustrating an effect of the embodiment.

In FIGS. 9 and 10, the reference numerals P1 and P2 denote power supply points, the reference numerals Si1 to Si3 denote signal input terminals, and the reference numerals So1 to So3 denote signal output terminals.

The effect in FIG. 9 corresponds to the design data obtained through a conventional design process. As illustrated in FIG. 9, since the peak voltage drop point distance is not considered in the conventional design process, sometimes, the first cell is placed in a region near the peak voltage drop point Pmax while the second cell is placed in the region far away from the peak voltage drop point Pmax. In such cases, a supply voltage drop error E0 becomes relatively large, and a yield is decreased when the semiconductor integrated circuit is produced based on such design data.

The effect in FIG. 10 corresponds to the design data (that is, the optimized design data) obtained through the design process of the embodiment. As illustrated in FIG. 10, since the peak voltage drop point distance is considered in S108 (particularly, in S108-42) of the design process of the embodiment, the second cell is placed in the region near the peak voltage drop point Pmax while the first cell is placed in the region far away from the peak voltage drop point Pmax. In this case, a supply voltage drop error E1 is smaller than the supply voltage drop error E0 (that is, the case of the conventional design process), and the yield can be improved when the semiconductor integrated circuit is produced based on the design data by comparison of the conventional design process.

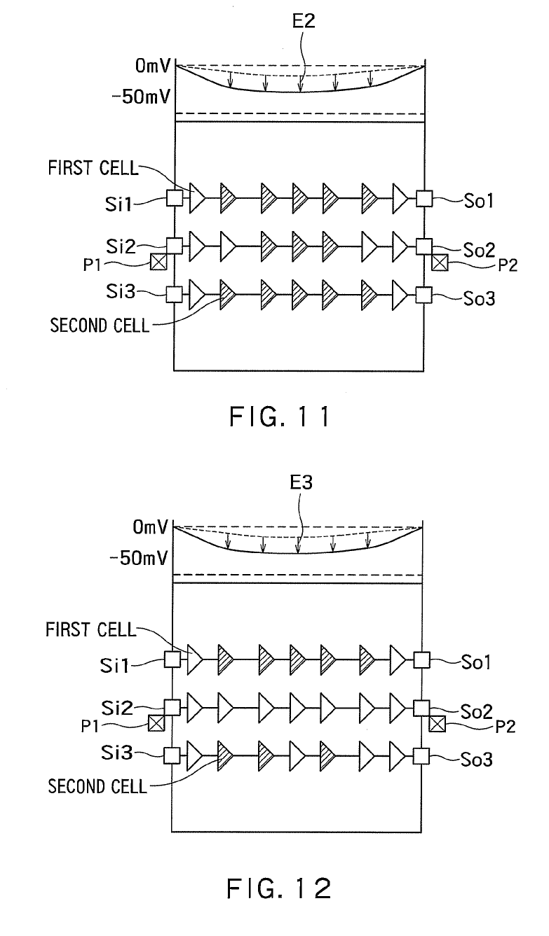

A first modification of the embodiment will be described. FIG. 11 is an explanatory view illustrating an effect of the first modification of the embodiment.

In FIG. 11, the reference numerals P1 and P2 denote power supply points, the reference numerals Si1 to Si3 denote signal input terminals, and the reference numerals So1 to So3 denote signal output terminals.

In the first modification of the embodiment, in S108-42, the second cell replacing module 122 extracts the second replacement candidate cell based on distances from the power supply points P1 and P2 instead of the peak voltage drop point distance. For example, the second cell replacing module 122 extracts the second cell, which is located farthest away from the power supply points P1 and P2, as the second replacement candidate cell.

Therefore, as illustrated in FIG. 11, the first cell is placed in the region near the power supply points P1 and P2 while the second cell is placed in the region far away from the power supply points P1 and P2. In this case, a supply voltage drop error E2 is smaller than the supply voltage drop error E0 (that is, the case of the conventional design process), and the yield can be improved when the semiconductor integrated circuit is produced based on the design data by comparison of the conventional design process.

A second modification of the embodiment will be described. FIG. 12 is an explanatory view illustrating an effect of the second modification of the embodiment.

In FIG. 12, the reference numerals P1 and P2 denote power supply points, the reference numerals Sit to Si3 denote signal input terminals, and the reference numerals So1 to So3 denote signal output terminals.

In the second modification of the embodiment, in S108-42, the second cell replacing module 122 extracts the second replacement candidate cell based on a power supply routing impedance instead of the peak voltage drop point distance. The power supply routing impedance means impedance on the power supply routing between the power supply point P1 or P2 and the cell. For example, the second cell replacing module 122 extracts the second cell having the minimum power supply routing impedance as the second replacement candidate cell.

Therefore, as illustrated in FIG. 12, the most cells of second cell group are placed in positions in which the power supply routing impedance becomes the maximum (that is, farthest away from the power supply point P1 or P2) while most cells of the first cell group are placed in positions in which the power supply routing impedance becomes a minimum (that is, nearest from the power supply point P1 or P2).

In this case, a supply voltage drop error E3 is smaller than the supply voltage drop error E0 (that is, the case of the conventional design process), and the yield can be improved when the semiconductor integrated circuit is produced based on the design data by comparison of the conventional design process.

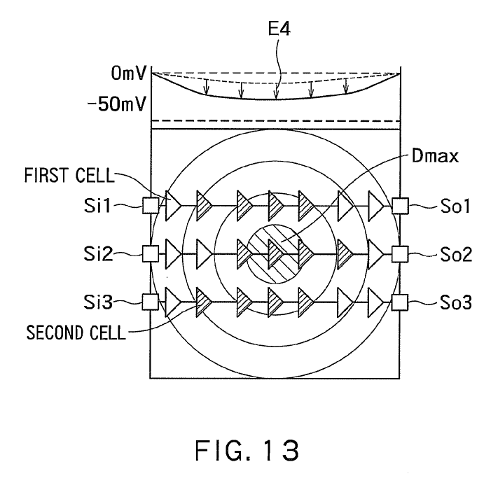

A third modification of the embodiment will be described. FIG. 13 is an explanatory view illustrating an effect of the third modification of the embodiment.

In FIG. 13, the reference numerals P1 and P2 denote power supply points, the reference numerals Si1 to Si3 denote signal input terminals, and the reference numerals So1 to So3 denote signal output terminals.

In the third modification of the embodiment, in S108-42, the second cell replacing module 122 extracts the second replacement candidate cell based on a distance (hereinafter referred to as a “power density highest point distance”) from a point (hereinafter referred to as a “power density highest point”), at which density of power consumption becomes the maximum, instead of the peak voltage drop point distance. For example, the second cell replacing module 122 extracts the second cell, which is located farthest away from the power density highest point, as the second replacement candidate cell.

Therefore, as illustrated in FIG. 13, the second cell is placed in the region near a power density highest point Dmax while the first cell is placed in the region far away from the power density highest point Dmax. In this case, a supply voltage drop error E4 is smaller than the supply voltage drop error E0 (that is, the case of the conventional design process), and the yield can be improved when the semiconductor integrated circuit is produced based on the design data by comparison of the conventional design process.

Incidentally, the embodiment and the first to third modifications of the embodiment can be combined with each other. The optimized design data can further be optimized by the combination thereof.

As described above, in the embodiment, the second cell replacing module 122 may sort each cell of the second cell group based on the timing improvement, may extract the second cell having the timing improvement larger than the first timing threshold as the first replacement candidate cell, and may change the design data changed by the first cell replacing module 121 such that the first replacement candidate cell is replaced by the first cell.

Moreover, as described above, in the embodiment, when the number of first replacement candidate cell is less than the upper limit, the second cell replacing module 122 may extract at least one cell of the second cell group in each of which the timing improvement is equal to or smaller than the first timing threshold as the second replacement candidate cell, and may change the design data changed by the first cell replacing module 121 such that the first replacement candidate cell and the second replacement candidate cell are replaced by the first cell.

Moreover, as described above, in the embodiment, the second cell replacing module 122 may determine the acceptable range around the second timing threshold smaller than the first timing threshold, and may extract at least one cell of the second cell group included in the acceptable range as the second replacement candidate cell.

Moreover, as described above, in the embodiment, the second cell replacing module 122 may extract the second replacement candidate cell such that the total number of the first and second replacement candidate cells is equal to the upper limit.

Moreover, as described above, in the embodiment, based on the distance from the peak voltage drop point, the second cell replacing module 122 may change the design data changed by the first cell replacing module 121 such that the replacement candidate cell is replaced by the first cell.

Moreover, as described above, in the embodiment, based on the distance from the power supply point of the target device, the second cell replacing module 122 may change the design data changed by the first cell replacing module 121 such that the replacement candidate cell is replaced by the first cell.

Moreover, as described above, in the embodiment, based on the power supply routing impedance of the target device, the second cell replacing module 122 may change the design data changed by the first cell replacing module 121 such that the replacement candidate cell is replaced by the first cell.

Moreover, as described above, in the embodiment, based on the distance from the power density highest point at which the density of the power consumption of the target device becomes the maximum, the second cell replacing module 122 may change the design data changed by the first cell replacing module 121 such that the replacement candidate cell is replaced by the first cell.

Moreover, as described above, in the embodiment, based on the distance from the center of the target device, the second cell replacing module 122 may change the design data changed by the first cell replacing module 121 such that the replacement candidate cell is replaced by the first cell.

Moreover, as described above, in the embodiment, in the case that the target device includes the memory cell, based on the distance from the memory cell, the second cell replacing module 122 may change the design data changed by the first cell replacing module 121 such that the replacement candidate cell is replaced by the first cell.

Moreover, as described above, in the embodiment, the design apparatus 10 may further include: the first analyzer 141 that calculates the operation timing corresponding to the design data changed by the first cell replacing module 121; the second analyzer 142 that calculates the operation timing corresponding to the design data changed by the second cell replacing module 122; and the timing rule checker that, based on the constraint data indicating the timing constraint of the target device, determines whether the operation timing calculated by the first analyzer 141 meets the timing constraint and determines whether the operation timing calculated by the second analyzer 142 meets the timing constraint.

At least a portion of the design apparatus 10 according to the above-described embodiments may be composed of hardware or software. When at least a portion of the design apparatus 10 is composed of software, a program for executing at least some functions of the design apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the design apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A design apparatus comprising:
a voltage drop analyzer configured to specify a peak voltage drop point at which the voltage drop amount becomes a maximum based on a cell library and design data, the cell library comprising information on a first cell group and information on a second cell group, each cell of the first cell group operated by a first operational threshold, each cell of the second cell group operated by a second operational threshold higher than the first operational threshold, the design data indicating a hardware configuration of a target device comprising the first cell group;
a first cell replacing module configured to change the design data in such a manner that each cell of the first cell group replaceable on a data path is replaced by each cell of the second cell group;
an improvement calculator configured to calculate a timing improvement that is amount of improved operation timing, the timing improvement being obtained by replacing each cell of the second cell group, which is comprised in the target device corresponding to the design data changed by the first cell replacing module, by each cell of the first cell group;
a second cell replacing module configured to extract at least one cell from the second cell group in the target device corresponding to the design data changed by the first cell replacing module as a replacement candidate cell, based on the timing improvement, and to change the design data changed by the first cell replacing module in such a manner that the replacement candidate cell is replaced by each cell of the first cell group; and
an outputting module configured to output the design data changed by the second cell replacing module.

2. The apparatus of claim 1,
wherein the second cell replacing module
sorts the second cell group based on the timing improvement,
extracts at least one cell of the second cell group having the timing improvement larger than the first timing threshold as a first replacement candidate cell, and
changes the design data changed by the first cell replacing module in such a manner that the first replacement candidate cell is replaced by each cell of the first cell group.

3. The apparatus of claim 2,
wherein the second cell replacing module further
extracts at least one cell of the second cell group in which the timing improvement is equal to or smaller than the first timing threshold as a second replacement candidate cell when the first replacement candidate cell is less than an upper limit, and
changes the design data changed by the first cell replacing module in such a manner that the first replacement candidate cell and the second replacement candidate cell are replaced by each cell of the first cell group.

4. The apparatus of claim 3,
wherein the second cell replacing module
determines an acceptable range around a second timing threshold smaller than the first timing threshold, and
extracts at least one cell of the second cell group in the acceptable range as the second replacement candidate cell.

5. The apparatus of claim 3, wherein the second cell replacing module extracts the second replacement candidate cell in such a manner that the total number of the first and second replacement candidate cells is equal to the upper limit.

6. The apparatus of claim 1, wherein, based on a distance from the peak voltage drop point, the second cell replacing module changes the design data changed by the first cell replacing module in such a manner that the replacement candidate cell is replaced by each cell of the first cell group.

7. The apparatus of claim 2, wherein, based on a distance from the peak voltage drop point, the second cell replacing module changes the design data changed by the first cell replacing module in such a manner that the replacement candidate cell is replaced by each cell of the first cell group.

8. The apparatus of claim 3, wherein, based on a distance from the peak voltage drop point, the second cell replacing module changes the design data changed by the first cell replacing module in such a manner that the replacement candidate cell is replaced by each cell of the first cell group.

9. The apparatus of claim 1, wherein, based on a distance from a power supply point of the target device, the second cell replacing module changes the design data changed by the first cell replacing module in such a manner that the replacement candidate cell is replaced by each cell of the first cell group.

10. The apparatus of claim 2, wherein, based on a distance from a power supply point of the target device, the second cell replacing module changes the design data changed by the first cell replacing module in such a manner that the replacement candidate cell is replaced by each cell of the first cell group.

11. The apparatus of claim 3, wherein, based on a distance from a power supply point of the target device, the second cell replacing module changes the design data changed by the first cell replacing module in such a manner that the replacement candidate cell is replaced by each cell of the first cell group.

12. The apparatus of claim 6, wherein, based on a distance from a power supply point of the target device, the second cell replacing module changes the design data changed by the first cell replacing module in such a manner that the replacement candidate cell is replaced by each cell of the first cell group.

13. The apparatus of claim 7, wherein, based on a distance from a power supply point of the target device, the second cell replacing module changes the design data changed by the first cell replacing module in such a manner that the replacement candidate cell is replaced by each cell of the first cell group.

14. The apparatus of claim 1, wherein, based on a routing impedance, the second cell replacing module changes the design data changed by the first cell replacing module in such a manner that the replacement candidate cell is replaced by each cell of the first cell group.

15. The apparatus of claim 1, wherein, based on a distance from a power density highest point at which density of power consumption of the target device becomes a maximum, the second cell replacing module changes the design data changed by the first cell replacing module in such a manner that the replacement candidate cell is replaced by each cell of the first cell group.

16. The apparatus of claim 1, wherein, based on a distance from a center of the target device, the second cell replacing module changes the design data changed by the first cell replacing module in such a manner that the replacement candidate cell is replaced by each cell of the first cell group.

17. The apparatus of claim 1, wherein, when the target device comprises a memory cell, based on a distance from the memory cell, the second cell replacing module changes the design data changed by the first cell replacing module in such a manner that the replacement candidate cell is replaced by each cell of the first cell group.

18. The apparatus of claim 1, further comprising:
a first analyzer configured to calculate the operation timing corresponding to the design data changed by the first cell replacing module;
a second analyzer configured to calculate the operation timing corresponding to the design data changed by the second cell replacing module; and
a timing checker configured, based on the constraint data indicating the timing constraint of the target device, to determine whether the operation timing calculated by the first analyzer meets the timing constraint and to determine whether the operation timing calculated by the second analyzer meets the timing constraint.

19. A method for designing a semiconductor integrated circuit, the method comprising:
specifying a peak voltage drop point at which the voltage drop amount becomes a maximum based on a cell library and design data, the cell library comprising information on a first cell group and information on a second cell group, each cell of the first cell group operated by a first operational threshold, each cell of the second cell group operated by a second operational threshold higher than the first operational threshold, the design data indicating a hardware configuration of a target device comprising the first cell group;
changing the design data in such a manner that each cell of the first cell group replaceable on a data path is replaced by each cell of the second cell group;
calculating a timing improvement that is amount of improved operation timing, the timing improvement being obtained by replacing each cell of the second cell group, which is comprised in the target device corresponding to the design data changed by the first cell replacing module, by each cell of the first cell group;
extracting at least one cell from the second cell group in the target device corresponding to the design data changed by the first cell replacing module as a replacement candidate cell, based on the timing improvement;
changing the design data changed by the first cell replacing module in such a manner that the replacement candidate cell is replaced by each cell of the first cell group; and
outputting the design data changed by the second cell replacing module.

20. A non-transitory medium storing a program for designing a semiconductor integrated circuit, the program comprising:
specifying a peak voltage drop point at which the voltage drop amount becomes a maximum based on a cell library and design data, the cell library comprising information on a first cell group and information on a second cell group, each cell of the first cell group operated by a first operational threshold, each cell of the second cell group operated by a second operational threshold higher than the first operational threshold, the design data indicating a hardware configuration of a target device comprising the first cell group;
changing the design data in such a manner that each cell of the first cell group replaceable on a data path is replaced by each cell of the second cell group;
calculating a timing improvement that is amount of improved operation timing, the timing improvement being obtained by replacing each cell of the second cell group, which is comprised in the target device corresponding to the design data changed by the first cell replacing module, by each cell of the first cell group;
extracting at least one cell from the second cell group in the target device corresponding to the design data changed by the first cell replacing module as a replacement candidate cell, based on the timing improvement;
changing the design data changed by the first cell replacing module in such a manner that the replacement candidate cell is replaced by each cell of the first cell group; and
outputting the design data changed by the second cell replacing module.
